(19) United States
(12) Patent Application Publication
(10) Pub. No.: US 2019/0038091 A1
(43) Pub. Date: Feb. 7, 2019

(54) GAS DRIVEN AUTOMATIC MOVING STEAM CIRCULATION WINDOW WIPING ROBOT

(71) Applicant: Siu Tung Nam, Hong Kong (HK)

(72) Inventor: Siu Tung Nam, Hong Kong (HK)

(21) Appl. No.: 15/697,473

(22) Filed: Sep. 7, 2017

(30) Foreign Application Priority Data
Aug. 1, 2017 (CN) 201710647999.2

(51) Int. Cl. A47L 1/02; B08B 1/00; B08B 3/00; F16B 47/00

(52) U.S. Cl. CPC A47L 1/02; B08B 1/006; A47L 11/4066; F16B 47/00; A47L 2201/00; B08B 3/00

(57) ABSTRACT

The present invention relates to a gas driven automatic moving steam circulation window wiping robot, comprises a housing, a driving mechanism, a wiping mechanism and a steam circulation mechanism. The driving mechanism comprises a main drive shaft, a follower shaft, a first motor, a rolling wheel, a suction cup walking device. The suction cup moving device comprises a crankshaft, a support pole, suction cups and a second motor. The wiping mechanism comprises a striped wiping cloth, a UV sterilization lamp and rotary brushes. The follower shaft is drivably connected to the rotary brush. The steam circulation mechanism comprises a negative pressure suction mouth, a negative pressure pump, a water precipitation tank, a filter tank and a steam generator connected in series through pipes. The structure is reasonable, having the advantages of simple, convenient to use, saves water, safe and reliable, and having a high level of automation, can effectively solve the problem of existing window wiping robots unable to clean the corners of windows.

### FIELD OF INVENTION

The present invention relates to the field of window wiping robots, in particular to a gas driven automatic moving steam circulation window wiping robot.

### BACKGROUND OF INVENTION

Due to advancement in technology in the modern society, people's lives are getting more comfortable. To reduce the burden of people outside work time, many cleaning robots have appeared in the market. Especially for window wiping which is a job that causes some danger, robots are more needed as a substitution. For windows which are standing straight to the ground, safety of the robot needs to be specially addressed, also whether the wiping is clean and thorough is an important factor to be considered. However, existing window wiping robots has some issues such as missing corners when wiping and bad wiping results. When using a single piece of wiping cloth or brush for wiping, cleaning of the cloth is not always possible, the effectiveness will be lowered after prolonged use, and affects operation efficiency. Water for wiping windows cannot be circulated, not only wasting water resources, dirty water also affects the cleanliness of the environment. Window wiping robots all has safety ropes, they easily tie up during moving, not only affecting operation, but also causes safety concerns.

### SUMMARY OF INVENTION

The technical problem to be solved by the present invention is: to overcome the aforementioned problem, a gas driven automatic moving steam circulation window wiping robot is provided. The structure is reasonable, having the advantages of simple, convenient to use, saves water, safe and reliable, and having a high level of automation, can effectively solve the problem of existing window wiping robots unable to clean the corners of windows.

The technical solution used in the present invention to solve the technical problem is: a gas driven automatic moving steam circulation window wiping robot, comprises a housing with an opening opened at a bottom thereof, a driving mechanism, a wiping mechanism and a steam circulation mechanism. Round grooves, a battery, a microcontroller and a gas pump are disposed on the housing. The driving mechanism and the steam circulation mechanism are disposed at a chamber of the housing.

The driving mechanism comprises a main drive shaft, a follower shaft, a first motor, a rolling wheel, a suction cup walking device. Two ends of the main drive shaft and the follower shaft is rotatably connected to the housing, the first motor fixedly mounted on the housing is drivably connected to the main drive shaft, the rolling wheel is fixedly connected to the two ends of the main drive shaft.

The suction cup moving device comprises a crankshaft, a support pole, suction cups and a second motor. The two ends of the crankshaft are rotatably connected to the housing through bearings, rotator rings are disposed on the crankshaft. The support pole is rotatably connected to the crankshaft through the rotator rings, suction cups are disposed on the support pole. The suction cups are connected to the gas pump. The second motor is fixedly mounted on the housing and is drivably connected to one end of the crankshaft.

The wiping mechanism comprises a striped wiping cloth disposed on the main drive shaft and the follower shaft, a UV sterilization lamp and rotary brushes disposed at two ends of the follower shaft. The UV sterilization lamp is disposed on the side cover of the striped wiping cloth. The follower shaft comprises a square shaped hollow chamber, a blocker is disposed inside the chamber of the follower shaft, square shaped sliders are disposed at two ends of the blocker, damper springs are connectedly disposed between the square shaped slider and the blocker. The square shaped slider is drivably connected to the rotary brush through a spline shaft.

The steam circulation mechanism comprises a negative pressure suction mouth, a negative pressure pump, a water precipitation tank, a filter tank and a steam generator connected in series through pipes. The negative pressure suction mouth is abut against the striped wiping cloth. The filter tank comprises a first chamber, a second chamber and a third chamber. The steam generator comprises an electric heater, a vaporization tank and a steam nozzle. A number of heat guide poles are disposed at the electric heater extending into the vaporization tank, a electromagnetic valve connected to the vaporization tank is disposed at a bottom of the third chamber.

In a preferred embodiment, a safety loop is slidably connected to the inside of the round groove through a ball head.

In a preferred embodiment, a power switch for controlling the operation of the present invention is disposed on the housing.

In a preferred embodiment, a membrane pressure sensor is disposed between the rotator ring and the crankshaft.

In a preferred embodiment, a wiping cloth tensing device is disposed at an inside of the striped wiping cloth, the wiping cloth tensing device comprises a spinning wheel abut against the inside of the striped wiping cloth and a slide pole connected to the spinning wheel, the slide pole penetrates through the housing and is connected to an adjustment bolt, a tension spring is inserted at the slide pole.

In a preferred embodiment, a number of triangular protrusions is disposed at the striped wiping cloth.

In a preferred embodiment, a filter net is disposed inside the second chamber.

In a preferred embodiment, the microcontroller is electrically connected to the battery, the gas pump, the negative pressure pump, the first motor, the second motor, the electric heater, the electromagnetic valve, the power switch, the UV sterilization lamp.

The advantage of the present invention is: the gas driven automatic moving steam circulation window wiping robot of the present invention, comprises a housing with an opening at a bottom thereof, a driving mechanism, a wiping mechanism, a steam circulation system. The driving mechanism and the steam circulation mechanism is disposed inside the housing, the round grooves disposed on the housing allows safety ropes to fit therein, preventing the ropes from tying together, thus enhancing the safety of window wiping robots. The wiping mechanism comprises a striped wiping cloth and a rotary brush disposed inside the housing, the striped wiping cloth wipes the central portion of the window, and the rotary brush wipes the edges and corners of the window, covering all areas thus wiping is cleaner. The driving mechanism supports the housing through rolling wheels, and attaches the present invention to the window through suction cups, and can move along windows through suction cup walking device, enhancing safety. The steam circulation mechanism collects and filters the water from the striped wiping cloth and converts into steam for the striped wiping cloth to use, saves water and steam helps cleaning dirt and provides bacteria killing effect. The structure is reasonable, having the advantages of simple, convenient to use, saves water, safe and reliable, and having a high level of automation, can effectively solve the problem of existing window wiping robots unable to clean the corners of windows.

### BRIEF DESCRIPTION OF DRAWINGS

The present invention is further explained below with the accompanying drawings and embodiments.

FIG. 1 is a bottom structural schematic diagram of a gas driven automatic moving steam circulation window wiping robot according to the present invention.

FIG. 2 is a side structural schematic diagram of a gas driven automatic moving steam circulation window wiping robot according to the present invention.

FIG. 3 is a structural schematic diagram of a suction cup walking device of a gas driven automatic moving steam circulation window wiping robot according to the present invention.

FIG. 4 is a structural schematic diagram of a negative pressure suction mouth of a gas driven automatic moving steam circulation window wiping robot according to the present invention.

FIG. 5 is a side structural schematic diagram of a filter tank and steam generator of a gas driven automatic moving steam circulation window wiping robot according to the present invention.

FIG. 6 is a side structural schematic diagram of a follower shaft of a gas driven automatic moving steam circulation window wiping robot according to the present invention.

FIG. 7 is a side structural schematic diagram of a wiping cloth tensing device of a gas driven automatic moving steam circulation window wiping robot according to the present invention.

FIG. 8 is a side structural schematic diagram of a housing of a gas driven automatic moving steam circulation window wiping robot according to the present invention.

FIG. 9 is a side structural schematic diagram of a round groove of a gas driven automatic moving steam circulation window wiping robot according to the present invention.

Reference numbers in the drawings: 1 housing, 11 round groove, 12 UV sterilization lamp, 13 battery, 14 microcontroller, 15 power switch, 16 ball head, 17 safety loop, 18 gas pump, 2 driving mechanism, 21 main drive shaft, 22 follower shaft, 221 square slider, 222 blocking piece, 223 damper spring, 23 first motor, 24 rolling wheel, 25 suction cup walking device, 251 crankshaft, 252 support pole, 253 rotator ring, 254 suction cup, 255 second motor, 256 bearing, 3 wiping mechanism, 31 striped wiping cloth, 32 rotary brush, 33 wiping cloth tensing device, 331 spinning wheel, 332 slide pole, 333 adjustment bolt, 334 tension spring, 34 triangular protrusion, 4 steam circulation mechanism, 41 negative pressure suction mouth, 42 negative pressure pump, 43 water precipitation tank, 44 filter tank, 441 first chamber, 442 second chamber, 443 third chamber, 444 electromagnetic valve, 45 steam generator, 451 electric heater, 452 heat guide pole, 453 vaporization tank, 454 steam nozzle.

### DETAILED DESCRIPTION OF INVENTION

The present invention is further explained below along with the accompanying drawings. The drawings are all simplified schematic diagrams which only illustrates the basic structure of the present invention, as such only the components material to the present invention are shown.

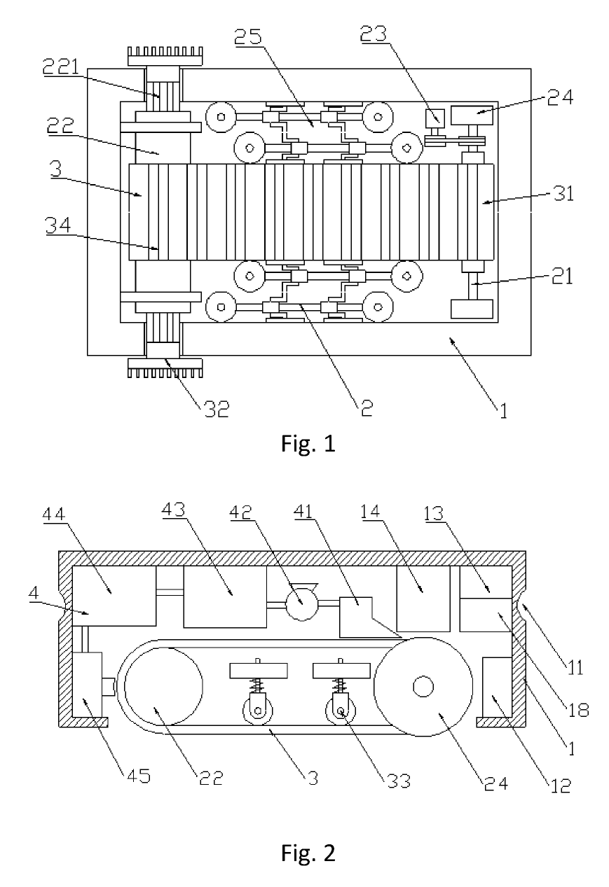

A gas driven automatic moving steam circulation window wiping robot is shown in FIGS. 1-4. The robot comprises a housing 1 with an opening opened at a bottom thereof, a driving mechanism 2, a wiping mechanism 3 and a steam circulation mechanism 4. Round grooves 11, a battery 13, a microcontroller 14 and a gas pump 18 are disposed on the housing 1. The driving mechanism 2 and the steam circulation mechanism 4 are disposed at a chamber of the housing 1.

The driving mechanism 2 comprises a main drive shaft 21, a follower shaft 22, a first motor 23, a rolling wheel 24, a suction cup walking device 25. Two ends of the main drive shaft 21 and the follower shaft 22 is rotatably connected to the housing 1, the first motor 23 fixedly mounted on the housing 1 is drivably connected to the main drive shaft 21, the rolling wheel 24 is fixedly connected to the two ends of the main drive shaft 21.

In a possible embodiment, suction cups 254 are disposed on the rolling wheel 24, the suction cups 254 are connected to a gas pump 18.

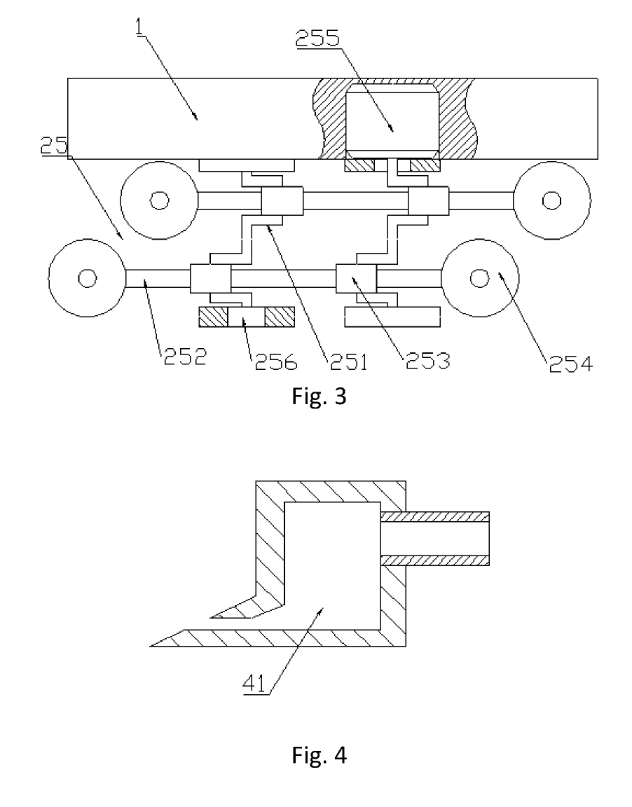

As shown in FIGS. 1 and 3, the suction cup moving device 25 comprises a crankshaft 251, a support pole 252, suction cups 254 and a second motor 255. The two ends of the crankshaft 251 are rotatably connected to the housing 1 through bearings 256, rotator rings 253 are disposed on the crankshaft 251. The support pole 252 is rotatably connected to the crankshaft 251 through the rotator rings 253, suction cups 254 are disposed on the support pole 252. The suction cups 254 are connected to the gas pump 18. The second motor 255 is fixedly mounted on the housing 1 and is drivably connected to one end of the crankshaft 251.

As shown in FIGS. 1, 2 and 6, the wiping mechanism 3 comprises a striped wiping cloth 31 disposed on the main drive shaft 21 and the follower shaft 22, a UV sterilization lamp 12 and rotary brushes 32 disposed at two ends of the follower shaft 22. The UV sterilization lamp 12 is disposed on the side cover of the striped wiping cloth 31. The follower shaft 22 comprises a square shaped hollow chamber, a blocker 222 is disposed inside the chamber of the follower shaft 22, square shaped sliders 221 are disposed at two ends of the blocker 222, damper springs 223 are connectedly disposed between the square shaped slider 221 and the blocker 222. The square shaped slider 221 is drivably connected to the rotary brush 32 through a spline shaft. The damper spring 223 prevents the present invention to fall when colliding with corners of windows, enhancing safety.

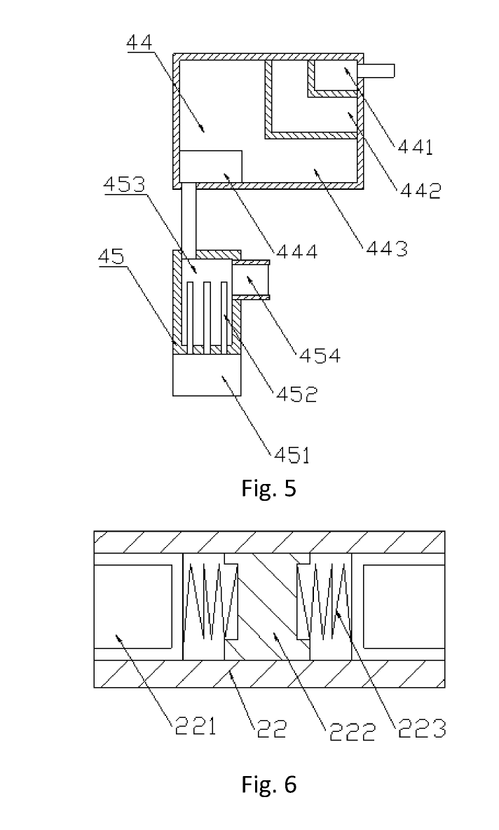

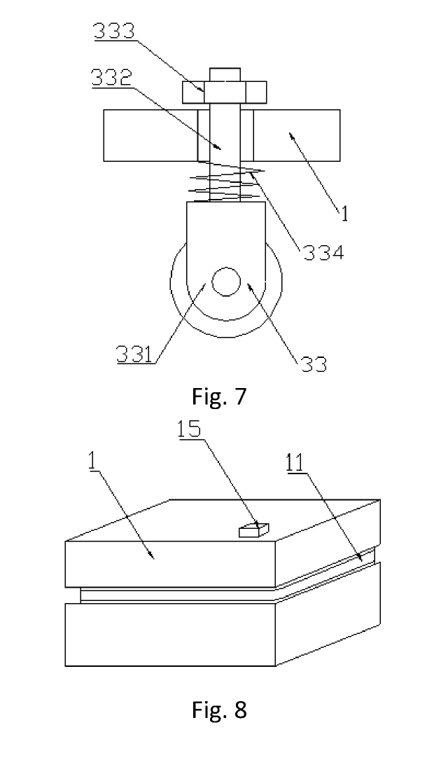

As shown in FIGS. 2 and 5, the steam circulation mechanism 4 comprises a negative pressure suction mouth 41, a negative pressure pump 42, a water precipitation tank 43, a filter tank 44 and a steam generator 45 connected in series through pipes. The negative pressure suction mouth 41 is abut against the striped wiping cloth 31. The filter tank 44 comprises a first chamber 441, a second chamber 442 and a third chamber 443. The steam generator 45 comprises an electric heater 451, a vaporization tank 453 and a steam nozzle 454. A number of heat guide poles 452 are disposed at the electric heater 451 extending into the vaporization tank 453, a electromagnetic valve 444 connected to the vaporization tank 453 is disposed at a bottom of the third chamber 443.

The third chamber 443 stores filtered clean water, and is slowly released by the electromagnetic valve 444, clean water is quickly vaporized when contacting the heat guide pole 452, steam is sprayed onto the window through steam nozzle 454 to be used by the wiping mechanism 3.

In one embodiment, a filter net is disposed inside the second chamber 442, the second chamber 442 can obviously has other solid, liquid or combined filtering media disposed.

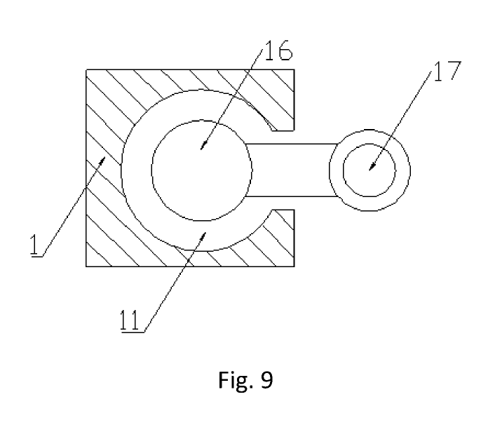

As shown in FIG. 9, a safety loop 17 is slidably connected to the inside of the round groove 11 through a ball head 16.

As shown in FIG. 8, a power switch 15 for controlling the operation of the present invention is disposed on the housing 1. In a possible embodiment, a power switch 15 is not disposed on the housing, the microcontroller 14 connects to an external remote control through wireless communication.

In another possible embodiment, a membrane pressure sensor is disposed between the rotator ring 253 and the crankshaft 251. In another possible embodiment, a membrane pressure sensor is disposed between the crankshaft 251 and the bearing 256. In another possible embodiment, the support pole 252 is connected to the suction cup 254 through a pressure sensor. The pressure sensor detects whether the suction cup 254 properly attaches to the window.

As shown in FIGS. 2 and 9, a wiping cloth tensing device 33 is disposed at an inside of the striped wiping cloth 31, the wiping cloth tensing device 33 comprises a spinning wheel 331 abut against the inside of the striped wiping cloth 31 and a slide pole 332 connected to the spinning wheel 331, the slide pole 332 penetrates through the housing 1 and is connected to an adjustment bolt 333, a tension spring 334 is inserted at the slide pole 332. Striped wiping cloth 31 tenses under the action of the wiping cloth tensing device 33, the tension spring 334 is further pushed inwards when the striped wiping cloth 31 meets a protrusion, preventing damaging striped wiping cloth 31.

In a possible embodiment, a number of triangular protrusions 34 for scraping dirt from windows is disposed at the striped wiping cloth 31, the protrusions 34 can also be semicircular, or any elongated shape that has a straight axial surface.

The microcontroller 14 is electrically connected to the battery 13, the gas pump 18, the negative pressure pump 42, the first motor 23, the second motor 255, the electric heater 451, the electromagnetic valve 444, the power switch 15, the UV sterilization lamp 12.

The gas driven automatic moving steam circulation window wiping robot of the present invention, comprises a housing with an opening at a bottom thereof, a driving mechanism, a wiping mechanism, a steam circulation system. The driving mechanism and the steam circulation mechanism is disposed inside the housing, the round grooves disposed on the housing allows safety ropes to fit therein, preventing the ropes from tying together, thus enhancing the safety of window wiping robots. The wiping mechanism comprises a striped wiping cloth and a rotary brush disposed inside the housing, the striped wiping cloth wipes the central portion of the window, and the rotary brush wipes the edges and corners of the window, covering all areas thus wiping is cleaner. The driving mechanism supports the housing through rolling wheels, and attaches the present invention to the window through suction cups, and can move along windows through suction cup walking device, enhancing safety. The steam circulation mechanism collects and filters the water from the striped wiping cloth and converts into steam for the striped wiping cloth to use, saves water and steam helps cleaning dirt and provides bacteria killing effect. The structure is reasonable, having the advantages of simple, convenient to use, saves water, safe and reliable, and having a high level of automation, can effectively solve the problem of existing window wiping robots unable to clean the corners of windows.

As revealed by the preferred embodiments of the present invention, based on the aforementioned description, a person skilled in the art can make various modifications and adjustments without departing from the technical concept of the present invention. The technical scope of the present invention is not limited to the specification but is defined by the scope of the claims.

What is claimed is:

1. A gas driven automatic moving steam circulation window wiping robot, comprises a housing with an opening opened at a bottom thereof, a driving mechanism, a wiping mechanism and a steam circulation mechanism; round grooves, a battery, a microcontroller and a gas pump are disposed on the housing; the driving mechanism and the steam circulation mechanism are disposed at a chamber of the housing;
the driving mechanism comprises a main drive shaft, a follower shaft, a first motor, a rolling wheel, a suction cup walking device; two ends of the main drive shaft and the follower shaft is rotatably connected to the housing, the first motor fixedly mounted on the housing is drivably connected to the main drive shaft, the rolling wheel is fixedly connected to the two ends of the main drive shaft;
the suction cup moving device comprises a crankshaft, a support pole, suction cups and a second motor; the two ends of the crankshaft are rotatably connected to the housing through bearings, rotator rings are disposed on the crankshaft; the support pole is rotatably connected to the crankshaft through the rotator rings, suction cups are disposed on the support pole; the suction cups are connected to the gas pump; the second motor is fixedly mounted on the housing and is drivably connected to one end of the crankshaft;
the wiping mechanism comprises a striped wiping cloth disposed on the main drive shaft and the follower shaft, a UV sterilization lamp and rotary brushes disposed at two ends of the follower shaft; the UV sterilization lamp is disposed on the side cover of the striped wiping cloth; the follower shaft comprises a square shaped hollow chamber, a blocker is disposed inside the chamber of the follower shaft, square shaped sliders are disposed at two ends of the blocker, damper springs are connectedly disposed between the square shaped slider and the blocker; the square shaped slider is drivably connected to the rotary brush through a spline shaft;
the steam circulation mechanism comprises a negative pressure suction mouth, a negative pressure pump, a water precipitation tank, a filter tank and a steam generator connected in series through pipes; the negative pressure suction mouth is abut against the striped wiping cloth; the filter tank comprises a first chamber, a second chamber and a third chamber; the steam generator comprises an electric heater, a vaporization tank and a steam nozzle; a number of heat guide poles are disposed at the electric heater extending into the vaporization tank, a electromagnetic valve connected to the vaporization tank is disposed at a bottom of the third chamber.

2. The gas driven automatic moving steam circulation window wiping robot according to claim 1, characterized in that: a safety loop is slidably connected to the inside of the round groove through a ball head.

3. The gas driven automatic moving steam circulation window wiping robot according to claim 1, characterized in that: a power switch for controlling the operation of the present invention is disposed on the housing.

4. The gas driven automatic moving steam circulation window wiping robot according to claim 1, characterized in that: a membrane pressure sensor is disposed between the rotator ring and the crankshaft.

5. The gas driven automatic moving steam circulation window wiping robot according to claim 1, characterized in that: a wiping cloth tensing device is disposed at an inside of the striped wiping cloth, the wiping cloth tensing device comprises a spinning wheel abut against the inside of the striped wiping cloth and a slide pole connected to the spinning wheel, the slide pole penetrates through the housing and is connected to an adjustment bolt, a tension spring is inserted at the slide pole.

6. The gas driven automatic moving steam circulation window wiping robot according to claim 1, characterized in that: a number of triangular protrusions is disposed at the striped wiping cloth.

7. The gas driven automatic moving steam circulation window wiping robot according to claim 1, characterized in that: a filter net is disposed inside the second chamber.

8. The gas driven automatic moving steam circulation window wiping robot according to claim 1, characterized in that: the microcontroller is electrically connected to the battery, the gas pump, the negative pressure pump, the first motor, the second motor, the electric heater, the electromagnetic valve, the power switch, the UV sterilization lamp.
